(19) United States
(12) Patent Application Publication
(10) Pub. No.: US 2023/0126418 A1
(43) Pub. Date: Apr. 27, 2023

(54) HYDROGENATED POLYMERS AND RUBBER COMPOSITIONS INCORPORATING THE SAME

(71) Applicant: Bridgestone Corporation, Chuo-ku (JP)

(72) Inventors: Yoshihiko Kanatomi, Chuo-ku (JP); Jeffrey M. Magistrelli, Richfield, OH (US); Ryan J. Hue, Akron, OH (US); Yuan Liu, Copley, OH (US)

(21) Appl. No.: 17/778,068

(22) PCT Filed: Nov. 19, 2020
(86) PCT No.: PCT/US2020/061385

§ 371 Date: May 19, 2022

Related U.S. Application Data
(60) Provisional application No. 62/937,520, filed on Nov. 19, 2019.

(51) Int. Cl. C08F 236/10; C08L 15/00; C08K 3/36; C08K 3/06

(52) U.S. Cl. CPC C08F 236/10; C08L 15/00; C08K 3/36; C08K 3/06

(57) ABSTRACT

Embodiments of the present disclosure are directed to functional polymers produced by copolymerization of at least one conjugated diolefin monomer and optionally one or more vinyl monomer, the functional polymer comprising at least one functional group having silica reactive moieties, wherein the functional copolymer has a degree of hydrogenation of from 40% to 98 mol % and a vinyl content of about 50% or less.

### TECHNICAL FIELD

Embodiments of the present disclosure are generally related to hydrogenated polymers, and are specifically related to hydrogenated, functional polymers for use in rubber compositions for tire applications.

### BACKGROUND

Rubber tires employing tire treads have been used for more than a century. Because the tire tread provides the interface between the tire and the road surface, the tire tread performance correlates to the drivability of the vehicle. Accordingly, there is a continual need for improved rubber compositions which increase the performance of the tire treads.

### SUMMARY

Embodiments of the present disclosure are directed to hydrogenated, functional conjugated diene polymers, methods of making the same and rubber compositions comprising such hydrogenated, functional conjugated diene polymers. Certain embodiments relate to methods for achieving reduced wear or improved durability in a tire tread or tire sidewall comprising the hydrogenated, functional conjugated diene polymers.

One embodiment of the present disclosure is directed to a hydrogenated, functional conjugated diene polymer produced by polymerization of at least one conjugated diolefin monomer, the functional polymer comprising at least one functional group having silica reactive moieties, wherein the functional polymer has a degree of hydrogenation of 40% to 98 mol % as measured using proton nuclear magnetic resonance spectroscopy (¹H NMR), a vinyl content of from about 15% to about 50%; an Mn of from about 100,000 to about 700,000 grams/mole; and wherein the Tg of the functional polymer is from about −100° C. to −40° C.

Another embodiment of the present disclosure is directed to a method of making a hydrogenated, functional conjugated diene polymer and the polymers resulting from said method. The method comprises the steps of: introducing an anionic polymerization initiator, at least one conjugated diolefin monomer and solvent to a reactor to produce a living polymer via anionic polymerization; reacting at least one functional group comprising silica reactive moieties with the living polymer to produce a functional polymer; and hydrogenating the functional polymer by mixing the functional polymer with solvent and a hydrogenation catalyst in a hydrogen stream, wherein the hydrogenated functional polymer has a degree of hydrogenation of 40% to 98 mol % as measured using ¹H NMR; a vinyl content of from about 15% to about 50%; an Mn of from about 100,000 to about 700,000 grams/mole; and a Tg of from about −100° C. to −40° C.

In a third embodiment, the present disclosure is directed to a rubber composition, and tire treads made therefrom, comprising (a) 100 phr of an elastomer component comprising a hydrogenated functional polymer produced by polymerization of at least one conjugated diolefin monomer and optionally one or more aromatic vinyl monomers, the functional polymer comprising at least one functional group having silica reactive moieties, and wherein the functional polymer has a degree of hydrogenation of 40% to 98 mol % as measured using proton nuclear magnetic resonance spectroscopy (¹H NMR); a vinyl content of from about 15% to about 50%; an Mn of from about 100,000 to about 700,000 grams/mole; and a Tg of from about −100° C. to −40° C.; (b) silica reinforcing filler; and (c) a cure package.

Additional features and advantages of the embodiments described herein will be set forth in the detailed description which follows, and in part will be readily apparent to those skilled in the art from that description or recognized by practicing the embodiments described herein, including the detailed description which follows, and the claims.

### DETAILED DESCRIPTION

The present disclosure will now be described by reference to more detailed embodiments, but the disclosure should not be construed as limited to the embodiments set forth herein. Rather, these embodiments are provided so that this disclosure will be thorough and complete, and will fully convey the subject matter to those skilled in the art.

Unless otherwise defined, all technical and scientific terms used herein have the same meaning as commonly understood by one of ordinary skill in the art. The terminology used in the disclosure herein is for describing particular embodiments only and is not intended to be limiting. As used in the specification and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

### Definitions

The terminology as set forth herein is for description of the embodiments only and should not be construed as limiting the scope of the disclosure as a whole.

As used herein, the term “phr” means the parts by weight of rubber. If the rubber composition comprises more than one rubber, “phr” means the parts by weight per hundred parts of the sum of all rubbers.

As used herein, the term “polybutadiene” is used to indicate a polymer that is manufactured from 1,3-butadiene monomers. The term polybutadiene is also used interchangeably with the phrase “polybutadiene rubber” and the abbreviation “BR.”

As used herein, the term “styrene-butadiene polymer”, “styrene-butadiene rubber” or “SBR” means a polymer manufactured from styrene and 1,3-butadiene monomers.

As used herein, the term “natural rubber” or “NR” means naturally occurring rubber such as can be harvested from sources such as Hevea rubber trees, and non-Hevea source (e.g., guayule shrubs).

As used herein, the term “copolymer” refers to a polymer produced from two or more monomers, and thus could encompass copolymers produced from two monomers or more than two monomers, such as terpolymers.

As used herein, “rubber composition” refers to the polymer (e.g., the functional, hydrogenated polymer) and the additional fillers and additives blended therewith for use in tire and non-tire applications.

As used herein, “vinyl content” refers to the percentage of 1,2-vinyl double bonds in the polymer.

Embodiments of the present disclosure are directed to hydrogenated, functional conjugated diene polymers produced from the polymerization of at least one conjugated diolefin monomer and optionally at least one vinyl monomer. The functional polymer comprises at least one functional group having silica reactive moieties, and the functional polymer has a degree of hydrogenation of 40% to 98 mol % as measured using proton nuclear magnetic resonance spectroscopy (¹H NMR). Further embodiments are directed to rubber compositions comprising these hydrogenated, functional polymers.

Additional embodiments are directed to methods of making the hydrogenated functional polymers. The method comprises introducing an anionic polymerization initiator, at least one conjugated diolefin monomer, and optionally at least one vinyl aromatic monomer, and solvent to a reactor to produce a living polymer via anionic polymerization; reacting at least one functional group comprising silica reactive moieties with the living polymer to produce a functional polymer; and hydrogenating the functional polymer by mixing the functional polymer with a solvent and a hydrogenation catalyst, wherein the hydrogenated functional polymer has a degree of hydrogenation of at least 40 mol % as measured using ¹H NMR.

Monomers

Various monomers are contemplated for the conjugated diolefin monomers and the optional vinyl monomers.

The conjugated diolefin monomers may include various hydrocarbon compositions. For example, the conjugated diolefins include those having from about 4 to about 12 carbon atoms such as 1,3-butadiene, 1,3-cyclohexadiene, isoprene, 1,3-pentadiene, 1,3-hexadiene, 2,3-dimethyl-1,3-butadiene, 2-ethyl-1,3-butadiene, 2-methyl-1,3 pentadiene, 3-methyl-1,3-pentadiene, 4-methyl-1,3-pentadiene, and 2,4-hexadiene, or combinations thereof. The conjugated diolefins also may encompass trienes such as myrcene.

The optional vinyl monomers may polymerize with the conjugated diolefin monomers to produce a polymer or terpolymers. The vinyl aromatic monomers may comprise hydrocarbons having from about 8 to about 20 carbon atoms, or from about 8 to 10 carbon atoms. These vinyl aromatic monomers may include vinyl aromatic monomers, for example, monovinyl aromatic hydrocarbons. In one or more embodiments, the vinyl monomers may comprise styrene, alpha-methyl styrene, 1-vinylnaphthalene, 2-vinylnaphthalene, 1-alpha-methylvinylnaphthalene, 2-alphamethyl-vinylnaphthalene, and mixtures of these as well as halo, alkoxy, alkyl, cycloalkyl, aryl, alkaryl and aralkyl derivatives thereof in which the total number of carbon atoms in the combined hydrocarbon is generally not greater than 12. Examples of these latter compounds include 4-methylstyrene, vinyl toluene, 3,5-diethylstyrene, 2-ethyl-4-benzylstyrene, 4-phenylstyrene, 4-para-tolylstyrene, and 4,5-dimethyl-1-vinylnaphthalene, or mixtures thereof.

The polymers may comprise from about 80 to about 100% by weight, or about 82 to about 98% by weight, or about 85 to 95% by weight of the conjugated diolefin monomers. Alternatively, the polymers comprise at least about 80% by weight, or at least about 85% by weight, or at least about 90% by weight or at least about 95% by weight, or at least about 98% by weight of the conjugated diolefin monomers. In certain embodiments, the polymers comprise about 100% by weight conjugated diolefin monomer. Conversely, the polymers may comprise from 0 to about 20% by weight, or about 2 to about 18% by weight, or about 5% to about 15% by weight of vinyl monomers. Alternatively, in certain embodiments, the polymers comprise less than 20% by weight, less than 15% by weight, less than 10% by weight, less than 7% by weight, less than 5% by weight or less than 2% by weight vinyl monomer. In certain embodiments, the polymers exclude vinyl monomer (ie. have 0% by weight vinyl monomer). The polymers may be random polymers or block polymers. In one embodiment, the conjugated diolefin monomer is 1,3-butadiene and the vinyl monomer is styrene, which polymerize to produce styrene butadiene polymers. In specific embodiments, the polymer is a random styrene butadiene polymer.

Solvents

The polymerizations of the present disclosure may be conducted in the presence of solvent, for example, an inert solvent. The term “inert solvent” means that the solvent does not enter into the structure of the resulting polymer, does not adversely affect the properties of the resulting polymer, and does not adversely affect the activity of the catalyst employed. Suitable inert solvents include hydrocarbon solvents which may contain aromatic, aliphatic or cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. Non-limiting examples of cycloaliphatic hydrocarbons include cyclopentane, cyclohexane, methylcyclopentane, and methylcyclohexane. Mixtures of the above hydrocarbons may also be used. Ethers such as tetrahydrofuran and tertiary amines such as triethylamine and tributylamine may also be used as solvents, but these may modify the polymerization as to styrene distribution, vinyl content and rate of reaction. In one or more embodiments, the solvents may comprise hexane, or blends and mixtures of hexanes (e.g., linear and branched), for example, cyclohexane alone or mixed with other forms of hexane.

Anionic Polymerization Initiator

Various anionic polymerization initiators are contemplated for the anionic polymerization processes of the present disclosure. The anionic polymerization initiator may comprise a lithium catalyst, specifically, an organolithium anionic initiator catalyst. The organolithium initiator employed may be any anionic organolithium initiators useful in the polymerization of conjugated diolefin monomers (e.g., 1,3-butadiene monomers). In general, the organolithium compounds include hydrocarbon containing lithium compounds of the formula R(Li)x wherein R represents hydrocarbon groups containing from one to about 20 carbon atoms, and preferably from about 2 to about 8 carbon atoms, and x is an integer from 1 to 2. Although the hydrocarbon group is preferably an aliphatic group, the hydrocarbon group may also be cycloaliphatic or aromatic. The aliphatic groups may be primary, secondary, or tertiary groups although the primary and secondary groups are preferred. Examples of aliphatic hydrocarbyl groups include methyl, ethyl, n-propyl, isopropyl, n-butyl, sec-butyl, t-butyl, n-amyl, sec-amyl, n-hexyl, sec-hexyl, n-heptyl, n-octyl, n-nonyl, n-dodecyl, and octa-decyl. The aliphatic groups may contain some unsaturation such as allyl, 2-butenyl, and the like. Cycloalkyl groups are exemplified by cyclohexyl, methylcyclohexyl, ethylcyclohexyl, cycloheptyl, cyclopentylmethyl, and methylcyclopentylethyl. Examples of aromatic hydrocarbyl groups include phenyl, tolyl, phenylethyl, benzyl, naphthyl, phenyl cyclohexyl, and the like. Mixtures of different lithium initiator compounds also can be employed such as those containing one or more lithium compounds such as R(Li)x, R and x as defined above. Other lithium catalysts which can be employed alone or in combination with the hydrocarbyl lithium initiators are tributyl tin lithium, lithium dialkyl amines, lithium dialkyl phosphines, lithium alkyl aryl phosphines and lithium diaryl phosphines. In one embodiment, the organolithium initiator is n-butyl lithium.

The amount of initiator required to affect the desired polymerization can be varied over a wide range depending upon a number of factors such as the desired polymer molecular weight, the desired 1,2- and 1,4-content of the conjugated diene, and the desired physical properties for the polymer produced. In general, the amount of initiator utilized may vary from as little as 0.2 millimole of lithium per 100 grams of monomers up to about 100 millimoles of lithium per 100 grams of monomers, depending upon the desired polymer molecular weight (typically 1,000 to 10,000,000 grams/mole average molecular weight).

Polymerization is begun by introducing the monomer(s) and solvent to a suitable reaction vessel, followed by the addition of the anionic polymerization initiators. The polymerization reaction may be carried out in a batch polymerization reactor system or a continuous polymerization reactor system. Polymerization conditions such as temperature, pressure and time are well known in the art for polymerizing the monomers as described with the anionic polymerization initiator as described. For example, for illustrative purposes only, the temperature employed in the polymerization is generally not critical and may range from about −60° C. to about 150° C. Exemplary polymerization temperatures may range from about 25° C. to about 130° C. for a polymerization time of a few minutes to up to 24 hours or more, and employing pressures generally sufficient to maintain polymerization admixtures substantially in the liquid phase, for example, at or near atmospheric pressure, depending on the temperature and other reaction parameters. The procedure may be carried out under anhydrous, anaerobic conditions. Polymerization of any of the above-identified monomers in the presence of an organolithium initiator results in the formation of a “living” polymer. The lithium proceeds to move down the growing chain as polymerization continues. Throughout formation or propagation of the polymer, the polymeric structure may be anionic and living. In other words, a carbon anion is present. A new batch of monomer subsequently added to the reaction can add to the living ends of the existing chains and increase the degree of polymerization. A living polymer or polymer, therefore, may include a polymeric segment having an anionic reactive end.

Functional Groups

Functional groups may then be applied to the anionic reactive end of the living polymer to cap or terminate the living polymer. For the present functional polymers, the functional groups may be silica-reactive, and optionally carbon black reactive. The silica-reactive moieties encompass one or more reactive groups that will react with silica reinforcing filler to form an ionic or covalent bond. While many of the functional groups focus on being reactive with silica, it is contemplated that the functional group could be reactive with both silica and carbon black. Useful functional groups that react with silica typically are electron donors or are capable of reacting with a proton. Non-limiting examples of silica-reactive functional groups generally include nitrogen-containing functional groups, silicon-containing functional groups, oxygen- or sulfur-containing functional groups, and metal-containing functional groups, as discussed in more detail below.

Non-limiting examples of nitrogen-containing functional groups that can be utilized in certain embodiments as a silica-reactive functional group include, but are not limited to, a substituted or unsubstituted amino group, an amide residue, an isocyanate group, an imidazolyl group, an indolyl group, an imino group, a nitrile group, a pyridyl group, and a ketimine group. The foregoing substituted or unsubstituted amino group should be understood to include a primary alkylamine, a secondary alkylamine, or a cyclic amine, and an amino group derived from a substituted or unsubstituted imine. In certain embodiments, the functional polymer comprises at least one silica-reactive functional group selected from the foregoing list of nitrogen-containing functional groups.

In certain embodiments, the functional polymer includes a silica-reactive functional group from a compound which includes nitrogen in the form of an imino group. Such an imino-containing functional group may be added by reacting the active terminal of a polymer chain with a compound having the following Formula (I):

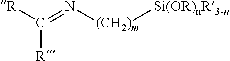

wherein R, R′, R″, and R′″ each independently are selected from a group having 1 to 18 carbon atoms selected from the group consisting of an alkyl group, an allyl group, and an aryl group; m and n are integers of 1 to 20 and 1 to 3, respectively. Each of R, R′, R″, and R′″ are preferably hydrocarbyl and contain no heteroatoms. In certain embodiments, each R and R′ are independently selected from an alkyl group having 1 to 6 carbon atoms, preferably 1 to 3 carbon atoms. In certain embodiments, m is an integer of 2 to 6, preferably 2 to 3. In certain embodiments, R′″ is selected from a group having 1 to 6 carbon atoms, preferably 2 to 4 carbon atoms. In certain embodiments, R″ is selected from an alkyl group having 1 to 6 carbon atoms, preferably 1 to 3 carbon atoms, most preferably 1 carbon atom (e.g., methyl). In certain embodiments, n is 3 resulting in a compound with a trihydrocarboxysilane moiety such as a trialkoxysilane moiety. Non-limiting examples of compounds having an imino group and meeting Formula (I) above, which are suitable for providing the silica-reactive functional group include, but are not limited to, N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, and N-(4-N,N-dimethylaminobenzylidene)-3-(triethoxysilyl)-1-propaneamine.

Non-limiting examples of silicon-containing functional groups that can be utilized in certain embodiments as a silica-reactive functional group include, but are not limited to, an organic silyl or siloxy group, and more precisely, the such functional group may be selected from an alkoxysilyl group, an alkylhalosilyl group, a siloxy group, an alkylaminosilyl group, and an alkoxyhalosilyl group. Optionally, the organic silyl or siloxy group may also contain one or more nitrogens. Suitable silicon-containing functional groups for use in functionalizing diene-based elastomer also include those disclosed in U.S. Pat. No. 6,369,167, the entire disclosure of which is herein incorporated by reference. In certain embodiments, the functional polymer comprises at least one silica-reactive functional group selected from the foregoing list of silicon-containing functional groups.

In certain embodiments wherein the functional polymer includes a silica-reactive functional group, the functional group preferably results from a silicon-containing compound having a siloxy group (e.g., a hydrocarbyloxysilane-containing compound), wherein the compound optionally includes a monovalent group having at least one functional group. Such a silicon-containing functional group may be added by reacting the active terminal of a polymer chain with a compound having the following Formula (II):

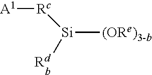

wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having 1 to 20 carbon atoms, a monovalent aromatic hydrocarbon group having 6 to 18 carbon atoms or a reactive group; R^{e} represents a monovalent aliphatic hydrocarbon group having 1 to 20 carbon atoms or a monovalent aromatic hydrocarbon group having 6 to 18 carbon atoms; b is an integer of 0 to 2; when more than one R^{d} or OR^{e} are present, each R^{d} and/or OR^{e} may be the same as or different from each other; and an active proton is not contained in a molecule) and/or a partial condensation product thereof. As used herein, a partial condensation product refers to a product in which a part (not all) of a SiOR group in the hydrocarbyloxysilane compound is turned into a SiOSi bond by condensation. In certain embodiments, at least one of the following is met: (a) R^{c} represents a divalent hydrocarbon group having 1 to 12 carbon atoms, 2 to 6 carbon atoms, or 2 to 3 carbon atoms; (b) R^{e} represents a monovalent aliphatic hydrocarbon group having 1 to 12 carbon atoms, 2 to 6 carbon atoms, or 1 to 2 carbon atoms or a monovalent aromatic hydrocarbon group having 6 to 8 carbon atoms; (c) R^{d} represents a monovalent aliphatic hydrocarbon group having 1 to 12 carbon atoms, 2 to 6 carbon atoms, or 1 to 2 carbon atoms or a monovalent aromatic hydrocarbon group having 6 to 8 carbon atoms; in certain such embodiments, each of (a), (b) and (c) are met and R^{c}, R^{e} and R^{d} are selected from one of the foregoing groups.

In certain embodiments, the functional group results from a compound represented by Formula (II) wherein A¹ has at least one epoxy group. Non-limiting specific examples of such compounds include 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, (3-glycidoxypropyl)-methyldimethoxysilane, 2-(3,4-epoxycyclohexyl)ethyltrimethoxysilane, 2-(3,4-epoxycyclohexyl)ethyltriethoxysilane, 2-(3,4-epoxycyclohexyl)ethyl(methyl)dimethoxysilane and the like. Among them, 3-glycidoxypropyltrimethoxysilane and 2-(3,4-epoxycyclohexyl)ethyltrimethoxysilane are particularly suited.

In certain embodiments, the functional group results from a compound represented by Formula (II) wherein A¹ has at least one isocyanate group. Non-limiting specific examples of such compounds include 3-isocyanatopropyltrimethoxysilane, 3-isocyanatopropyltriethoxysilane, 3-isocyanatopropylmethyldiethoxysilane, 3-isocyanatopropyltriisopropoxysilane and the like, and among them, 3-isocyanatopropyltrimethoxysilane is particularly preferred.

In certain embodiments, the functional group results from a compound represented by Formula (II) wherein A¹ has at least one imine group. Non-limiting specific examples of such compounds include N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, N-(cyclohexylidene)-3-(triethoxysilyl)-1-propaneamine and trimethoxysilyl compounds, methyldiethoxysilyl compounds, ethyldimethoxysilyl compounds and the like each corresponding to the above triethoxysilyl compounds. Among them, N-(1,3-dimethylbutylidene)-3-(triethoxysilyl)-1-propaneamine and N-(1-methylpropylidene)-3-(triethoxysilyl)-1-propaneamine are particularly suited. Also, the imine(amidine) group-containing compounds include preferably 1-[3-trimethoxysilyl]propyl]-4,5-dihydroimidazole, 3-(1-hexamethyleneimino)propyl(triethoxy)silane, (1-hexamethyleneimino)methyl(trimethoxy)silane, N-(3-triethoxysilylpropyl)-4,5-dihydroimidazole, N-(3-isopropoxysilylpropyl)-4,5-dihydroimidazole, N-(3-methyldiethoxysilylpropyl)-4,5-dihydroimidazole and the like, and among them, N-(3-triethoxysilylpropyl)-4,5-dihydroimidazole and N-(3-isopropoxysilylpropyl)-4,5-dihydroimidazole are preferred.

In certain embodiments, the functional group results from a compound represented by Formula (II) wherein A¹ has at least one carboxylic ester group. Non-limiting specific examples of such compounds include 3-methacryloyloxypropyltriethoxysilane, 3-methacryloyloxypropyltrimethoxysilane, 3-methacryloyloxypropylmethyldiethoxysilane, 3-methacryloyloxypropyltriisopropoxysilane and the like, and among them, 3-methacryloyloxypropyltriethoxysilane is preferred.

In certain embodiments, the functional group results from a compound represented by Formula (II) wherein A¹ has at least one carboxylic anhydride group. Non-limiting specific examples of such compounds include 3-trimethoxysilylpropylsuccinic anhydride, 3-triethoxysilylpropylsuccinic anhydride, 3-methyldiethoxysilylpropylsuccinic anhydride and the like, and among them, 3-triethoxysilylpropylsuccinic anhydride is preferred.

In certain embodiments, the functional group results from a compound represented by Formula (II) wherein A¹ has at least one cyano group. Non-limiting specific examples of such compounds include 2-cyanoethylpropyltriethoxysilane and the like.

In certain embodiments, the functional group results from a compound represented by Formula (II) wherein A¹ has at least one cyclic tertiary amine group. Non-limiting specific examples of such compounds include 3-(1-hexamethyleneimino)propyltriethoxysilane, 3-(1-hexamethyleneimino)propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl)propyltrimethoxysilane, 3-(1-pyrrolidinyl)propyltriethoxysilane, 3-(1-heptamethyleneimino)propyltriethoxysilane, 3-(1-dodecamethyleneimino)propyltriethoxysilane, 3-(1-hexamethyleneimino)propyldiethoxymethylsilane, 3-(1-hexamethyleneimino)propyldiethoxyethylsilane, 3-[10-(triethoxysilyl)decyl]-4-oxazoline and the like. Among them, 3-(1-hexamethyleneimino)propyltriethoxysilane and (1-hexamethyleneimino)methyltriethoxysilane can preferably be listed.

In certain embodiments, the functional group results from a compound represented by Formula (II) wherein A¹ has at least one non-cyclic tertiary amine group. Non-limiting specific examples of such compounds include 3-dimethylaminopropyltriethoxysilane, 3-dimethylaminopropyltrimethoxysilane, 3-diethylaminopropyltriethoxysilane, 3-dimethylaminopropyltrimethoxysilane, 2-dimethylaminoethyltriethoxysilane, 2-dimethylaminoethyltrimethoxysilane, 3-dimethylaminopropyldiethoxymethylsilane, 3-dibutylaminopropyltriethoxysilane and the like, and among them, 3-dimethylaminopropyltriethoxysilane and 3-diethylaminopropyltriethoxysilane are suited.

In certain embodiments, the functional group results from a compound represented by Formula (II) wherein A¹ has at least one pyridine group. Non-limiting specific examples of such compounds include 2-trimethoxysilylethylpyridine and the like.

In those embodiments wherein the functional polymer contains a silica-reactive functional group, the functional group preferably results from a compound represented by Formula (II) wherein A¹ has at least one silazane group. Non-limiting specific examples of such compounds include N,N-bis(trimethylsilyl)-aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, N,N-bis(trimethylsilyl)aminoethylmethyldiethoxysilane and the like. N,N-bis(trimethylsilyl)aminopropyltriethoxysilane, N,N-bis(trimethylsilyl)aminopropylmethyldiethoxysilane or 1-trimethylsilyl-2,2-dimethoxy-1-aza-2-silacyclopentane are particularly preferred.

In those embodiments wherein a silica-reactive functional group according to Formula (II) is used wherein A¹ contains one or more protected nitrogens (as discussed in detail above), the nitrogen may be deprotected or deblocked by hydrolysis or other procedures to convert the protected nitrogen(s) into a primary nitrogen. As a non-limiting example, a nitrogen bonded to two trimethylsilyl groups could be deprotected and converted to a primary amine nitrogen (such a nitrogen would still be bonded to the remainder of the Formula (II) compound). Accordingly, in certain embodiments wherein a silica-reactive functional group results from use of a compound according to Formula (II) wherein A¹ contains one or more protected nitrogens, the functional polymer can be understood as containing a functional group resulting from a deprotected (or hydrolyzed) version of the compound.

Non-limiting examples of oxygen- or sulfur-containing functional groups that can be utilized in certain embodiments as a silica-reactive functional group include, but are not limited to, a hydroxyl group, a carboxyl group, an epoxy group, a glycidoxy group, a diglycidylamino group, a cyclic dithiane-derived functional group, an ester group, an aldehyde group, an alkoxy group, a ketone group, a thiocarboxyl group, a thioepoxy group, a thioglycidoxy group, a thiodiglycidylamino group, a thioester group, a thioaldehyde group, a thioalkoxy group, and a thioketone group. In certain embodiments, the foregoing alkoxy group may be an alcohol-derived alkoxy group derived from a benzophenone. In certain embodiments, the functional polymer comprises at least silica-reactive functional group selected from the foregoing list of oxygen- or sulfur-containing functional groups.

The polymerization conditions and reactants may dictate how much of the functional group is added. In one or more embodiments, the functional group may be present in a molar ratio (to initiator) of about 0.15 to 2, or about 0.25 to 1.5, or about 0.5 to 1.

Additional Polymerization Ingredients

Additionally, in order to promote randomization in polymerization and to control vinyl content, one or more polymeric modifiers may optionally be added to the polymerization ingredients. Amounts of polymeric modifier may range from 0 to about 90 or more equivalents per equivalent of initiator (e.g., lithium catalyst). Compounds useful as polymeric modifiers are typically organic and include those having an oxygen or nitrogen hetero-atom and a non-bonded pair of electrons. Examples include dialkyl ethers of mono and oligo alkylene glycols, “crown” ethers, tertiary amines such as tetramethyethylene diamine (TMEDA), tetrahydrofuran (THF), 2,2-bis(2′-tetrahydrofuryl)propane, THF oligomers linear and cyclic oligomeric oxolanyl alkanes (e.g., cyclic oligomeric oxolanyl propanes), potassium t-amylate (KTA), or combinations thereof.

The process of the present disclosure may optionally also include a stabilizing agent, for example, a silane stabilizing agent. One suitable silane stabilizing agent is octyltriethoxysilane. Moreover, an antioxidant such as 2,6-di-t-butyl-4-methylphenol (also called butylated hydroxytoluene (BHT)) may be added to reduce the likelihood of Mooney viscosity instability due to oxidative coupling. The stabilizing agent may be added to the reactor or another mixer downstream of the reactor. Similarly, the antioxidant may be added to the reactor or another mixer downstream of the reactor.

Optionally, upon termination, the functional terminated polymer may be quenched, if necessary, and dried. Quenching may be conducted by contacting the functional polymer with a quenching agent for about 0.05 to about 2 hours at temperatures of from about 30° C. to about 120° C. to insure complete reaction. Suitable well-known quenching agents include alcohols, water, carboxylic acids such 2-ethyl hexanoic acid (EHA), acetic acid and the like. Coagulation is typically done with alcohols such as methanol or isopropanol. Alternative to, or in combination with, the step of quenching, the functional polymer may be drum dried as known in the art. The use of steam or high heat to remove solvent is also considered suitable.

Molecular Weight

The number average molecular weight (Mn) of the polymers prior to functionalization may be from about 5,000 to about 1,000,000 grams/mole, in other embodiments from about 75,000 to about 300,000 grams/mole, in other embodiments from about 100,000 to about 250,000 grams/mole, and in other embodiments from about 125,000 to about 225,000 grams/mole. The weight average molecular weight (Mw) of the polymers prior to functionalization may be from about 5,000 to about 1,000,000 grams/mole, in other embodiments from about 75,000 to about 300,000 grams/mole, in other embodiments from about 100,000 to about 250,000 grams/mole, and in other embodiments from about 125,000 to about 225,000 grams/mole. The molecular weight distribution or polydispersity (Mw/Mn) of these polymers may be from about 1.0 to about 4.0, and in other embodiments from about 1.0 to about 3.0, and in still other embodiments from about 1.0 to about 2.5. Post functionalization, the number average molecular weight (Mn) of the polymers may be from about 10,000 to about 1,500,000 grams/mole, in other embodiments from about 100,000 to about 700,000 grams/mole, in other embodiments from about 150,000 to about 600,000 grams/mole, and in other embodiments from about 200,000 to about 500,000 grams/mole. The weight average molecular weight (Mw) of the polymers after functionalization may be from about 10,000 to about 1,500,000 grams/mole, in other embodiments from about 100,000 to about 800,000 grams/mole, in other embodiments from about 200,000 to about 700,000 grams/mole, and in other embodiments from about 300,000 to about 650,000 grams/mole. The molecular weight distribution or polydispersity (Mw/Mn) of these polymers may be from about 1.0 to about 4.0, and in other embodiments from about 1.0 to about 3.0, and in still other embodiments from about 1.0 to about 2.5.

Hydrogenation

After production of the functional polymer, the functional polymer is hydrogenated by mixing the functional polymer with a solvent and a hydrogenation catalyst in the presence of a hydrogen stream. The solvent may include one or more of the solvents described above. In one embodiment, the hydrogenation catalyst comprises nickel. In further embodiments, the hydrogenation catalyst comprises nickel and aluminum. In one or more embodiments, the nickel of the hydrogenation catalyst comprises an organic nickel compound such as nickel octoate. For hydrogenation catalysts including nickel and aluminum, the aluminum may also include an organic aluminum compound. In one embodiment, the organic aluminum compound is triethylaluminum. The nickel and aluminum may be included in various amounts. For example, the aluminum and nickel may be added at an Al/Ni molar ratio of 1:1 to 5:1, or from 2:1 to 4:1.

In the hydrogenation process, pressurized hydrogen may be added at a pressure from 1 to 100 atm. Like the above polymerization, additional components, such as the quenching agents and antioxidants, may be added to the reactor.

In specific embodiments, the functional polymer has a degree of hydrogenation of 40% to 98 mol % as measured using proton nuclear magnetic resonance spectroscopy (¹H NMR) 65% to 95 mol % as measured using proton nuclear magnetic, or from or from 70% to 90 mol %, or from 72% to 88 mol %, or from 75% to 85 mol %.

While the hydrogenation reduces the number of double bonds, the functional polymer may, in one or more embodiments, have an initial vinyl content prior to hydrogenation of less than 50%, or less than 40%, or less than 30%, or less than 25%, or less than 20%, or less than 10%. In one of more embodiments the initial vinyl content prior to hydrogenation is from 10% to 50%, or from 15% to 44%, or from 20% to 40%.

Glass Transition Temperature

In one or more embodiments, the functional polymers can have a glass transition temperature (Tg) after hydrogenation that is less than −40° C., in other embodiments less than −50° C., and in other embodiments less than −60° C. In other embodiments, the glass transition temperature (Tg) after hydrogenation that is from −100 to −40° C., in other embodiments from −90 to −50° C., and in other embodiments from −85 to −60° C. In certain embodiment, these polymers may exhibit a single glass transition temperature and in other embodiments, these polymers may exhibit more than one glass transition temperature.

Rubber Compositions

As stated previously, the hydrogenated, functional polymers detailed above, may be included in rubber compositions for tire and non-tire applications.

Certain embodiments are directed to a tire rubber composition. The subject rubber compositions are used in preparing treads for tires, generally by a process which includes forming of a tread pattern by molding and curing one of the subject rubber compositions. Thus, the tire treads will contain a cured form of one of the tire tread rubber compositions. The tire tread rubber compositions may be present in the form of a tread which has been formed but not yet incorporated into a tire and/or they may be present in a tread which forms part of a tire.

Filler

As used herein, “reinforcing filler” may refer particulate material that has a nitrogen absorption specific surface area (N₂SA) of more than about 100 m²/g, and in certain instances more than 100 m²/g, more than about 125 m²/g, more than 125 m²/g, or even more than about 150 m²/g or more than 150 m²/g. Alternatively, “reinforcing filler” can also be used to refer to a particulate material that has a particle size of about 10 nm to about 50 nm. In one or more embodiments, the reinforcing filler may comprise silica, carbon black, other reinforcing fillers, and combinations thereof.

In certain embodiments where carbon black filler is present, the particular type or types of carbon black utilized may vary. Generally, suitable carbon blacks for use as a reinforcing filler in the rubber composition of certain embodiments include any of the commonly available, commercially-produced carbon blacks, including those having a surface area of at least about 20 m²/g (including at least 20 m²/g) and, more preferably, at least about 35 m²/g up to about 200 m²/g or higher (including 35 m²/g up to 200 m²/g). Surface area values used herein for carbon blacks are determined by ASTM D-1765 using the cetyltrimethyl-ammonium bromide (CTAB) technique. Various carbon black compositions are considered suitable. Among the useful carbon blacks are furnace black, channel blacks, and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks. In certain embodiments, the rubber composition includes a mixture of two or more of the foregoing carbon blacks.

Preferably in certain embodiments, if a carbon black filler is present it consists of only one type (or grade) of reinforcing carbon black. Typical suitable carbon blacks for use in certain embodiments include N-110, N-220, N-339, N-330, N-351, N-550, and N-660, as designated by ASTM D-1765-82a. The carbon blacks utilized can be in pelletized form or an unpelletized flocculent mass. Preferably, for more uniform mixing, unpelletized carbon black is preferred.

Various amounts of carbon black are contemplated. In certain embodiments, the tread rubber composition contains a limited amount (if any) of carbon black filler, i.e., no more than 15 phr of carbon black filler, no more than 10 phr of carbon black filler, or no more than 5 phr of carbon black filler. In certain embodiments, the tread rubber composition contains 0 phr of carbon black filler. In other embodiments, the total amount of the reinforcing carbon black filler is 5 to about 175 phr, including 5 to 175 phr, about 5 to about 150 phr, 5 to 150 phr, about 5 to about 100 phr, 5 to 100 phr, or about 10 to about 200 phr, including 10 to 200 phr, about 20 to about 175 phr, 20 to 175 phr, about 20 to about 150 phr, 20 to 150 phr, about 25 to about 150 phr, 25 to 150 phr, about 25 to about 100 phr, 25 to 100 phr, about 30 to about 150 phr, 30 to 150 phr, about 30 to about 125 phr, 30 to 125 phr, about 30 to about 100 phr, 30 to 100 phr, about 35 to 150 phr, 35 to 150 phr, about 35 to about 125 phr, 35 to 125 phr, about 35 to about 100 phr, 35 to 100 phr, about 35 to about 80 phr, and 35 to 80 phr.

Silica filler may also be used as reinforcing filler. Non-limiting examples of reinforcing silica fillers suitable for use include, but are not limited to, precipitated amorphous silica, wet silica (hydrated silicic acid), dry silica (anhydrous silicic acid), fumed silica, calcium silicate and the like. Other suitable silica fillers for use in rubber compositions of certain embodiments of the first-third embodiments disclosed herein include, but are not limited to, aluminum silicate, magnesium silicate (e.g., Mg₂SiO₄, MgSiO₃), magnesium calcium silicate (CaMgSiO₄), aluminum calcium silicate (e.g., Al₂O₃.CaO₂SiO₂), and the like.

Among the listed reinforcing silica fillers, precipitated amorphous wet-process, hydrated silica fillers are preferred. Such reinforcing silica fillers are produced by a chemical reaction in water, from which they are precipitated as ultrafine, spherical particles, with primary particles strongly associated into aggregates, which in turn combine less strongly into agglomerates. The surface area, as measured by the BET method, is a preferred measurement for characterizing the reinforcing character of different reinforcing silica fillers. In certain embodiments disclosed herein, the rubber composition comprises a reinforcing silica filler having a surface area (as measured by the BET method) of about 100 m²/g to about 400 m²/g, 100 m²/g to 400 m²/g, about 100 m²/g to about 350 m²/g, or 100 m²/g to 350 m²/g. In certain embodiments of the first-fourth embodiments disclosed herein, the rubber composition comprises a reinforcing silica filler having a BET surface area of about 150 m²/g to about 400 m²/g, 150 m²/g to 400 m²/g, with the ranges of about 170 m²/g to about 350 m²/g, 170 m²/g to 350 m²/g, about 170 m²/g to about 320 m²/g, and 170 m²/g to 320 m²/g being included; in certain such embodiments the only silica filler present in the rubber composition has a BET surface area within one of the foregoing ranges. In other embodiments disclosed herein, the rubber composition comprises a reinforcing silica filler having a BET surface of about 100 m²/g to about 140 m²/g, 100 m²/g to 140 m²/g, about 100 m²/g to about 125 m²/g, 100 m²/g to 125 m²/g, about 100 m²/g to about 120 m²/g, or 100 to 120 m²/g; in certain such embodiments the only silica filler present in the rubber composition has a BET surface area within one of the foregoing ranges. In certain embodiments disclosed herein, the rubber composition comprises reinforcing silica filler having a pH of about 5.5 to about 8, 5.5 to 8, about 6 to about 8, 6 to 8, about 6 to about 7.5, 6 to 7.5, about 6.5 to about 8, 6.5 to 8, about 6.5 to about 7.5, 6.5 to 7.5, about 5.5 to about 6.8, or 5.5 to 6.8. Some of the commercially available reinforcing silica fillers which can be used in certain embodiments include, but are not limited to, Hi-Sil® EZ120G, Hi-Sil® EZ120G-D, Hi-Sil® 134G, Hi-Sil®EZ 160G, Hi-Sil®EZ 160G-D, Hi-Sil®190, Hi-Sil®190G-D, Hi-Sil® EZ 200G, Hi-Sil® EZ 200G-D, Hi-Sil® 210, Hi-Sil® 233, Hi-Sil® 243LD, Hi-Sil® 255CG-D, Hi-Sil® 315-D, Hi-Sil® 315G-D, Hi-Sil® HDP 320G and the like, produced by PPG Industries (Pittsburgh, Pa.) As well, a number of useful commercial grades of different reinforcing silica fillers are also available from Evonik Corporation (e.g., Ultrasil® 320 GR, Ultrasil® 5000 GR, Ultrasil® 5500 GR, Ultrasil® 7000 GR, Ultrasil® VN2 GR, Ultrasil® VN2, Ultrasil® VN3, Ultrasil® VN3 GR, Ultrasil®7000 GR, Ultrasil® 7005, Ultrasil® 7500 GR, Ultrasil® 7800 GR, Ultrasil® 9500 GR, Ultrasil® 9000 G, Ultrasil® 9100 GR), and Solvay (e.g., Zeosil® 1115MP, Zeosil® 1085GR, Zeosil® 1165MP, Zeosil® 1200MP, Zeosil® Premium, Zeosil® 195HR, Zeosil® 195GR, Zeosil® 185GR, Zeosil® 175GR, and Zeosil® 165 GR).

Like the carbon black, various amounts of silica are contemplated for use as reinforcing filler. In one or more embodiments, the total amount of the reinforcing silica filler or silica filler may be about 5 to about 175 phr, including 5 to 175 phr, about 5 to about 150 phr, 5 to 150 phr, about 5 to about 100 phr, 5 to 100 phr, or about 10 to about 200 phr, including 10 to 200 phr, about 20 to about 175 phr, 20 to 175 phr, about 20 to about 150 phr, 20 to 150 phr, about 25 to about 150 phr, 25 to 150 phr, about 25 to about 100 phr, 25 to 100 phr, about 30 to about 150 phr, 30 to 150 phr, about 30 to about 125 phr, 30 to 125 phr, about 30 to about 100 phr, 30 to 100 phr, about 35 to 150 phr, 35 to 150 phr, about 555 to about 125 phr, 55 to 125 phr, about 55 to about 100 phr, 55 to 100 phr, about 35 to about 80 phr, and 35 to 80 phr.

In other embodiments, the rubber composition may comprise at least one reinforcing filler other than carbon black or silica, or alternatively in addition to reinforcing carbon black and reinforcing silica fillers. Non-limiting examples of suitable such reinforcing fillers for use in the rubber compositions disclosed herein include, but are not limited to, aluminum hydroxide, talc, alumina (Al₂O₃), aluminum hydrate (Al₂O₃H₂O), aluminum hydroxide (Al(OH)₃), aluminum carbonate (Al₂(CO₃)₂), aluminum magnesium oxide (MgOAl₂O₃), pyrofilite (Al₂O₃4SiO₂.H₂O), bentonite (Al₂O₃.4SiO₂.2H₂O), mica, kaolin, glass balloon, glass beads, calcium oxide (CaO), calcium hydroxide (Ca(OH)₂), calcium carbonate (CaCO₃), magnesium carbonate, magnesium hydroxide (Mg(OH)₂), magnesium oxide (MgO), magnesium carbonate (MgCO₃), potassium titanate, barium sulfate, zirconium oxide (ZrO₂), zirconium hydroxide [Zr(OH)₂.nH₂O], zirconium carbonate [Zr(CO₃)₂], crystalline aluminosilicates, reinforcing grades of zinc oxide (i.e., reinforcing zinc oxide), and combinations thereof. When at least one reinforcing filler other than or alternatively in addition to reinforcing carbon black filler and reinforcing silica filler) is present, the total amount of all reinforcing fillers is about 5 to about 200 phr including 5 to 200 phr). In other words, when at least one reinforcing filler is present in addition to carbon black silica, or both, the amount of reinforcing carbon black filler and reinforcing silica filler is adjusted so that the total amount of reinforcing filler is about 5 to about 200 phr (including 5 to 200 phr). In certain embodiments, the additional reinforcing filler may be utilized in an amount that is preferably limited to no more than 10 phr, or no more than 5 phr. In certain embodiments, the tread rubber composition contains no additional reinforcing filler (i.e., 0 phr); in other words, in such embodiments no reinforcing filler other than silica and optionally carbon black are present.

In certain embodiments, the tread rubber composition further comprises at least one non-reinforcing filler. In other embodiments, the tread rubber composition contains no non-reinforcing fillers (i.e., 0 phr). In embodiments wherein at least one non-reinforcing filler is utilized, the at least one non-reinforcing filler may be selected from clay (non-reinforcing grades), graphite, magnesium dioxide, aluminum oxide, starch, boron nitride (non-reinforcing grades), silicon nitride, aluminum nitride (non-reinforcing grades), calcium silicate, silicon carbide, ground rubber, and combinations thereof. The term “non-reinforcing filler” is used to refer to a particulate material that has a nitrogen absorption specific surface area (N₂SA) of less than about 20 m²/g (including less than 20 m²/g), and in certain embodiments less than about 10 m²/g (including less than 10 m²/g). The N₂SA surface area of a particulate material can be determined according to various standard methods including ASTM D6556. In certain embodiments, the term “non-reinforcing filler” is alternatively or additionally used to refer to a particulate material that has a particle size of greater than about 1000 nm (including greater than 1000 nm). In those embodiments wherein a non-reinforcing filler is present in the rubber composition, the total amount of non-reinforcing filler may vary but is preferably no more than 10 phr, and in certain embodiments 1-10 phr, no more than 5 phr, 1-5 phr, or no more than 1 phr.

Additional Rubber

In certain embodiments, the rubber composition comprises 100 parts total of an elastomer component. In addition to the hydrogenated, functional conjugated diene polymer, such elastomer component may comprise an additional rubber component comprising natural rubber, synthetic rubber, or combinations thereof. For example, and not by way of limitation, the synthetic rubber may comprise synthetic polyisoprene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, or combinations thereof.

In certain embodiments, the elastomer component is free of (i.e., contains 0 parts of) natural rubber and polyisoprene. In certain embodiments, the elastomer component comprises less than 50 parts, less than 30 parts or less than 20 parts; alternatively, the elastomer component comprises between 25-50 parts natural rubber, polyisoprene, or a combinations thereof. In yet other embodiments, the 100 parts of elastomer component includes one or more styrene-butadiene rubbers having a Tg of greater than −40° C. or less than −50° C. or between −80° C. and −30° C., or between −80° C. and −40° C. or between −80° C. and −50° C.; or one or more polybutadiene rubbers having a cis bond content of less than 95% e.g., a polybutadiene having a low cis 1, 4 bond content (e.g., a polybutadiene having a cis 1,4 bond content of less than 50%, less than 45%, less than 40%, etc.) and/or a Tg of less than −101° C.; or one or more polybutadiene rubbers having a cis bond content of greater than 85% e.g., a polybutadiene having a high cis 1, 4 bond content (e.g., a polybutadiene having a cis 1,4 bond content of greater than 85%, greater than 90%, greater than 95%, etc.) and/or a Tg of less than −101° C.); or from a diene-monomer containing rubber other than the natural rubber or polyisoprene; or a combination thereof. Such additional elastomer components may include silica reactive and optionally carbon black reactive functional groups, that are the same or different from the functional group(s) of the hydrogenated, functional conjugated diene polymer.

Silica Coupling Agent

In certain embodiments disclosed herein, one or more than one silica coupling agent may also (optionally) be utilized. Silica coupling agents are useful in preventing or reducing aggregation of the silica filler in rubber compositions. Aggregates of the silica filler particles are believed to increase the viscosity of a rubber composition, and, therefore, preventing this aggregation reduces the viscosity and improves the processability and blending of the rubber composition.

Generally, any conventional type of silica coupling agent can be used, such as those having a silane and a constituent component or moiety that can react with a polymer, particularly a vulcanizable polymer. The silica coupling agent acts as a connecting bridge between silica and the polymer. Suitable silica coupling agents for use in certain embodiments of the first-fourth embodiments disclosed herein include those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition. The use of a pre-treated silica can allow for two ingredients (i.e., silica and a silica coupling agent) to be added in one ingredient, which generally tends to make rubber compounding easier.

Alkyl alkoxysilanes have the general formula R¹⁰ₚSi(OR¹¹)₄₋ₚ where each R¹¹ is independently a monovalent organic group, and p is an integer from 1 to 3, with the proviso that at least one R¹⁰ is an alkyl group. Preferably p is 1. Generally, each R¹⁰ independently comprises C₁ to C₂₀ aliphatic, C₅ to C₂₀ cycloaliphatic, or C₆ to C₂₀ aromatic; and each R¹¹ independently comprises C₁ to C₆ aliphatic. In certain exemplary embodiments, each R¹⁰ independently comprises C₆ to C₁₅ aliphatic and in additional embodiments each R¹⁰ independently comprises C₈ to C₁₄ aliphatic. Mercapto silanes have the general formula HS—R¹³—Si(R¹⁴)(R¹⁵)₂ where R¹³ is a divalent organic group, R¹⁴ is a halogen atom or an alkoxy group, each R¹⁵ is independently a halogen, an alkoxy group or a monovalent organic group. The halogen is chlorine, bromine, fluorine, or iodine. The alkoxy group preferably has 1-3 carbon atoms. Blocked mercapto silanes have the general formula B—S—R¹⁶—Si—X₃ with an available silyl group for reaction with silica in a silica-silane reaction and a blocking group B that replaces the mercapto hydrogen atom to block the reaction of the sulfur atom with the polymer. In the foregoing general formula, B is a block group which can be in the form of an unsaturated heteroatom or carbon bound directly to sulfur via a single bond; R¹⁶ is C₁ to C₆ linear or branched alkylidene and each X is independently selected from the group consisting of C₁ to C₄ alkyl or C₁ to C₄ alkoxy.

Non-limiting examples of alkyl alkoxysilanes suitable for use in certain embodiments of the first-fourth embodiments include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano)polysulfides suitable for use in certain embodiments of the first-fourth embodiments include bis(trialkoxysilylorgano) disulfides and bis(trialkoxysilylorgano)tetrasulfides. Specific non-limiting examples of bis(trialkoxysilylorgano)disulfides include, but are not limited to, 3,3′-bis(triethoxysilylpropyl) disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis(trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof. Non-limiting examples of bis(trialkoxysilylorgano)tetrasulfide silica coupling agents suitable for use in certain embodiments of the first-fourth embodiments include, but are not limited to, bis(3-triethoxysilylpropyl)tetrasulfide, bis(2-triethoxysilylethyl) tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl)tetrasulfide is sold commercially as Si69® by Evonik Degussa Corporation.

Non-limiting examples of mercapto silanes suitable for use in certain embodiments of first-fourth embodiments disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiments of the first-fourth embodiments disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldiethoxysilylmethylthioacetate; methyldimethoxysilylmethylthioacetate; methyldiisopropoxysilylmethylthioacetate; dimethylethoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1 propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilylmethylmethylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is NXT™ silane (3-octanoylthio-1-propyltriethoxysilane), commercially available from Momentive Performance Materials Inc. of Albany, N.Y.

Non-limiting examples of pre-treated silicas (i.e., silicas that have been pre-surface treated with a silane) suitable for use in certain embodiments of the first-fourth embodiments disclosed herein include, but are not limited to, Ciptane® 255 LD and Ciptane® LP (PPG Industries) silicas that have been pre-treated with a mercaptosilane, and Coupsil® 8113 (Degussa) that is the product of the reaction between organosilane bis(triethoxysilylpropyl) polysulfide (Si69) and Ultrasil® VN3 silica. Coupsil 6508, Agilon 400™ silica from PPG Industries, Agilon 454® silica from PPG Industries, and 458® silica from PPG Industries. In those embodiments where the silica comprises a pre-treated silica, the pre-treated silica is used in an amount as previously disclosed for the silica filler (i.e., about 5 to about 200 phr, etc.).

When a silica coupling agent is utilized in an embodiment, the amount used may vary. In certain embodiments, the rubber compositions do not contain any silica coupling agent. In other embodiments, the silica coupling agent is present in an amount sufficient to provide a ratio of the total amount of silica coupling agent to silica filler of about 0.1:100 to about 1:5 (i.e., about 0.1 to about 20 parts by weight per 100 parts of silica), including 0.1:100 to 1:5, about 1:100 to about 1:10, 1:100 to 1:10, about 1:100 to about 1:20, 1:100 to 1:20, about 1:100 to about 1:25, and 1:100 to 1:25 as well as about 1:100 to about 0:100 and 1:100 to 0:100. In certain embodiments, the rubber composition comprises about 0.1 to about 15 phr silica coupling agent, including 0.1 to 15 phr, about 0.1 to about 12 phr, 0.1 to 12 phr, about 0.1 to about 10 phr, 0.1 to 10 phr, about 0.1 to about 7 phr, 0.1 to 7 phr, about 0.1 to about 5 phr, 0.1 to 5 phr, about 0.1 to about 3 phr, 0.1 to 3 phr, about 1 to about 15 phr, 1 to 15 phr, about 1 to about 12 phr, 1 to 12 phr, about 1 to about 10 phr, 1 to 10 phr, about 1 to about 7 phr, 1 to 7 phr, about 1 to about 5 phr, 1 to 5 phr, about 1 to about 3 phr, 1 to 3 phr, about 3 to about 15 phr, 3 to 15 phr, about 3 to about 12 phr, 3 to 12 phr, about 3 to about 10 phr, 3 to 10 phr, about 3 to about 7 phr, 3 to 7 phr, about 3 to about 5 phr, 3 to 5 phr, about 5 to about 15 phr, 5 to 15 phr, about 5 to about 12 phr, 5 to 12 phr, about 5 to about 10 phr, 5 to 10 phr, about 5 to about 7 phr, or 5 to 7 phr.

Plasticizers

As mentioned above, according to certain embodiments, the tread rubber composition comprises 5-60 phr of plasticizer, comprising liquid plasticizers (including but not limited to oils and esters) and resins. The term oil is meant to encompass both free oil (which is usually added during the compounding process) and extender oil (which is used to extend a rubber). Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. As is generally understood in the art, oils refer to those compounds that have a viscosity that is relatively low compared to other constituents of the vulcanizable composition, such as the resins. In certain embodiments, the total amount of liquid plasticizer is less than 50 phr, less than 40 phr, less than 30 phr, less than 20 phr, less than 10 phr or less than 5 phr or 0 phr (no liquid plasticizer is present in the composition). In other embodiments, the amount of liquid plasticizer in the rubber composition is from 5 phr to 60 phr, or from 5 phr to 40 phr, or from 5 phr to 30 phr, or from 5 phr to 20 phr.

In one or more embodiments, the plasticizer comprises one or more resins that may be solids with a Tg of greater than about 20° C., and may include, but are not limited to, hydrocarbon resins such as cycloaliphatic resins, aliphatic resins, aromatic resins, terpene resins, and combinations thereof. Useful resins include, but are not limited to, styrene-alkylene block copolymers, thermoplastic resins such as C₅-based resins, C₅-C₉-based resins, C₉-based resins, terpene-based resins, terpene-aromatic compound-based resins, rosin-based resins, dicyclopentadiene resins, alkylphenol-based resins, and their partially hydrogenated resins. In certain embodiments, the hydrocarbon resin comprises an aromatic resin optionally in combination with one or more additional resins selected from aliphatic, cycloaliphatic, and terpene resins. In certain embodiments, the hydrocarbon resin excludes any terpene resin (i.e., 0 phr of terpene resin is present in the tread rubber composition). In certain embodiments, the hydrocarbon resin has a softening point of about 60 to about 120° C., 70-120° C., alternatively about 70 to about 100° C., and preferably about 75 to about 95° C. or 75-95° C. In certain embodiments of, the hydrocarbon resin meets at least one of the following: (a) a Mw of 1000 to about 4000 grams/mole, 1000-4000 grams/mole, about 1000 to about 3000 grams/mole, 1000-3000 grams/mole, about 1000 to about 2500 grams/mole, 1000-2500 grams/mole, about 1000 to about 2000 grams/mole, 1000-2000 grams/mole, about 1100 to about 1800 grams/mole, or 1100-1800 grams/mole; (b) a Mn of about 700 to about 1500 grams/mole, 700-1500 grams/mole, about 800 to about 1400 grams/mole, 800-1400 grams/mole, about 800 to about 1300 grams/mole, 800-1300 grams/mole, about 900 to about 1200 grams/mole, or 900-1200 grams/mole; or (c) a polydispersity (Mw/Mn) of about 1 to about 2, 1-2, about 1.1 to about 1.8, 1.1-1.8, about 1.1 to about 1.7, 1.1-1.7, about 1.2 to about 1.5, or 1.2 to 1.5. In certain embodiments, the hydrocarbon resin has a Mw according to one of the ranges provided above, in combination with a Mn according to one of the ranges provided above, further in combination with a Mw/Mn according to one of the ranges provided above. In certain embodiments, the amount of resin present in the rubber composition is less than 50 phr, less than 40 phr, less than 30 phr, less than 20 phr, or less than 10 phr. In other embodiments, the amount of resin is from 8 phr to 40 phr, or from 10 phr to 30 phr, or from 15 phr to 25 phr.

Cure Package

As discussed above, according to certain embodiments disclosed herein, the tread rubber composition includes a cure package. Although the contents of the cure package may vary, generally, the cure package includes at least one of: a vulcanizing agent; a vulcanizing accelerator; a vulcanizing activator (e.g., zinc oxide, stearic acid, and the like); a vulcanizing inhibitor; and an anti-scorching agent. In certain embodiments, the cure package includes at least one vulcanizing agent, at least one vulcanizing accelerator, at least one vulcanizing activator and optionally a vulcanizing inhibitor and/or an anti-scorching agent. Vulcanizing accelerators and vulcanizing activators act as catalysts for the vulcanization agent. Various vulcanizing inhibitors and anti-scorching agents are known in the art and can be selected by one skilled in the art based on the vulcanizate properties desired.

Examples of suitable types of vulcanizing agents for use in certain embodiments, include but are not limited to, sulfur or peroxide-based curing components. Thus, in certain such embodiments, the curative component includes a sulfur-based curative or a peroxide-based curative. In preferred embodiments, the vulcanizing agent comprises a sulfur-based curative; in certain such embodiments, the vulcanizing agent consists (only) of a sulfur-based curative. Examples of specific suitable sulfur vulcanizing agents include “rubbermaker's” soluble sulfur; sulfur donating curing agents, such as an amine disulfide, polymeric polysulfide, or sulfur olefin adducts; and insoluble polymeric sulfur. Preferably, the sulfur vulcanizing agent is soluble sulfur or a mixture of soluble and insoluble polymeric sulfur. For a general disclosure of suitable vulcanizing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. Vulcanizing agents can be used alone or in combination. Generally, the vulcanizing agents may be used in certain embodiments of the first-fourth embodiments in an amount ranging from 0.1 to 10 phr, including from 1 to 7.5 phr, including from 1 to 5 phr, and preferably from 1 to 3.5 phr.

Vulcanizing accelerators are used to control the time and/or temperature required for vulcanization and to improve properties of the vulcanizate. Examples of suitable vulcanizing accelerators for use in certain embodiments disclosed herein include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. Generally, the amount of the vulcanization accelerator used ranges from 0.1 to 10 phr, preferably 0.5 to 5 phr.

Vulcanizing activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, in certain embodiments the amount of vulcanization activator used ranges from 0.1 to 6 phr, preferably 0.5 to 4 phr. In certain embodiments, one or more vulcanization activators are used which includes one or more thiourea compounds (used in the of the foregoing amounts), and optionally in combination with one or more of the foregoing vulcanization activators. Generally, a thiourea compound can be understood as a compound having the structure (R¹)(R²)NS(═C)N(R³)(R⁴) wherein each of R¹, R², R³, and R⁴ are independently selected from H, alkyl, aryl, and N-containing substituents (e.g., guanyl). Optionally, two of the foregoing structures can be bonded together through N (removing one of the R groups) in a dithiobiurea compound. In certain embodiments, one of R¹ or R² and one of R³ or R⁴ can be bonded together with one or more methylene groups (—CH₂—) therebetween. In certain embodiments of the first-fourth embodiments, the thiourea has one or two of R¹, R², R³ and R⁴ selected from one of the foregoing groups with the remaining R groups being hydrogen. Exemplary alkyl include C1-C6 linear, branched or cyclic groups such as methyl, ethyl, propyl, iso-propyl, butyl, iso-butyl, pentyl, hexyl, and cyclohexyl. Exemplary aryl include C6-C12 aromatic groups such as phenyl, tolyl, and naphthyl. Exemplary thiourea compounds include, but are not limited to, dihydrocarbylthioureas such as dialkylthioureas and diarylthioureas. Non-limiting examples of particular thiourea compounds include one or more of thiourea, N,N′-diphenylthiourea, trimethylthiourea, N,N′-diethylthiourea (DEU), N,N′-dimethylthiourea, N,N′-dibutylthiourea, ethylenethiourea, N,N′-diisopropylthiourea, N,N′-dicyclohexylthiourea, 1,3-di(o-tolyl)thiourea, 1,3-di(p-tolyl)thiourea, 1,1-diphenyl-2-thiourea, 2,5-dithiobiurea, guanylthiourea, 1-(1-naphthyl)-2-thiourea, 1-phenyl-2-thiourea, p-tolylthiourea, and o-tolylthiourea. In certain embodiments, the activator includes at least one thiourea compound selected from thiourea, N,N′-diethylthiourea, trimethylthiourea, N,N′-diphenylthiourea, and N—N′-dimethylthiourea.

Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Generally, in certain embodiments the amount of vulcanization inhibitor is 0.1 to 3 phr, preferably 0.5 to 2 phr.

Furthermore, the rubber compositions may also include other additives such as anti-ozonants, waxes, processing aids, fatty acid, and peptizers.

The anti-ozonants may comprise N,N′disubstituted-p-phenylenediamines, such as N-1,3-dimethylbutyl-N′phenyl-p-phenylenediamine (6PPD), N,N′-Bis(1,4-dimethylpentyl)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of anti-ozonants include, Acetone diphenylamine condensation product (Alchem BL), 2,4-Trimethyl-1,2-dihydroquinoline (TMQ), Octylated Diphenylamine (ODPA), and 2,6-di-t-butyl-4-methyl phenol (BHT).

Of the total elastomer component, in certain embodiments the hydrogenated, functional conjugated diene polymer may comprise from about 20 to about 100%, or about 25 to about 85%, and alternatively from about 30 to about 60 parts of the 100 total elastomer component. In other embodiments, the rubber composition comprises less than 69 phr, less than 59 phr, or less than 49 phr hydrogenated, functional conjugated diene polymer. Alternatively, in other embodiments the rubber composition comprises from 20 to 69 phr, from 25 to 59 phr, or from 30 to 49 phr hydrogenated, functional conjugated diene polymer.

Preparation of the Rubber Compositions

The particular steps involved in preparing the tread rubber compositions disclosed herein are generally those of conventionally practiced methods comprising mixing the ingredients in at least one non-productive master-batch stage and a final productive mixing stage. In certain embodiments, the tread rubber composition is prepared by combining the ingredients for the rubber composition (as disclosed above) by methods known in the art, such as, for example, by kneading the ingredients together in a Banbury mixer or on a milled roll. Such methods generally include at least one non-productive master-batch mixing stage and a final productive mixing stage. The term non-productive master-batch stage is known to those of skill in the art and generally understood to be a mixing stage (or stages) where no vulcanizing agents or vulcanization accelerators are added. The term final productive mixing stage is also known to those of skill in the art and generally understood to be the mixing stage where the vulcanizing agents and vulcanization accelerators are added into the rubber composition. In certain embodiments, the tread rubber composition is prepared by a process comprising more than one non-productive master-batch mixing stage.

In certain embodiments, the tread rubber composition is prepared by a process wherein the master-batch mixing stage includes at least one of tandem mixing or intermeshing mixing. Tandem mixing can be understood as including the use of a mixer with two mixing chambers with each chamber having a set of mixing rotors; generally, the two mixing chambers are stacked together with the upper mixing being the primary mixer and the lower mixer accepting a batch from the upper or primary mixer. In certain embodiments, the primary mixer utilizes intermeshing rotors and in other embodiments the primary mixer utilizes tangential rotors. Preferably, the lower mixer utilizes intermeshing rotors. Intermeshing mixing can be understood as including the use of a mixer with intermeshing rotors. Intermeshing rotors refers to a set of rotors where the major diameter of one rotor in a set interacts with the minor diameter of the opposing rotor in the set such that the rotors intermesh with each other. Intermeshing rotors must be driven at an even speed because of the interaction between the rotors. In contrast to intermeshing rotors, tangential rotors refers to a set of rotors where each rotor turns independently of the other in a cavity that may be referred to as a side. Generally, a mixer with tangential rotors will include a ram whereas a ram is not necessary in a mixer with intermeshing rotors.

Generally, the rubbers (or polymers) and at least one reinforcing filler (as well as any silane coupling agent and oil) will be added in a non-productive or master-batch mixing stage or stages. Generally, at least the vulcanizing agent component and the vulcanizing accelerator component of a cure package will be added in a final or productive mixing stage.

In certain embodiments, the tread rubber composition is prepared using a process wherein at least one non-productive master batch mixing stage conducted at a temperature of about 130° C. to about 200° C. In certain embodiments, the tread rubber composition is prepared using a final productive mixing stage conducted at a temperature below the vulcanization temperature in order to avoid unwanted pre-cure of the rubber composition. Therefore, the temperature of the productive or final mixing stage generally should not exceed about 120° C. and is typically about 40° C. to about 120° C., or about 60° C. to about 110° C. and, especially, about 75° C. to about 100° C. In certain embodiments, the tread rubber composition is prepared according to a process that includes at least one non-productive mixing stage and at least one productive mixing stage. The use of silica fillers may optionally necessitate a separate re-mill stage for separate addition of a portion or all of such filler. This stage often is performed at temperatures similar to, although often slightly lower than, those employed in the masterbatch stage, i.e., ramping from about 90° C. to a drop temperature of about 150° C.

Tire Tread Properties

According to certain embodiments disclosed herein, Mooney viscosity (ML1+4) values measured at 130° C. for the final rubber compositions are at least about 65, or at least about 70, at least about 80, or at least about 90, or at least about 100. Alternatively, the Mooney viscosity is between 65 to 180, or 70 to 170, or 80 to 160. The Mooney viscosity values of the rubber compositions are greater than the Mooney viscosity values of a comparably cured rubber compositions that contain non-hydrogenated, non-functional styrene-butadiene polymer in place of the hydrogenated, functional conjugated diene polymer, and which styrene-butadiene polymer has a Tg that is similar to that of the hydrogenated, functional conjugated diene polymer.

The use of the tire tread rubber composition of the of certain embodiments, may result in a tire having improved or desirable tread properties. These improved or desirable properties may include improved resistance to wear or improved durability. As used herein, the improvement in the wear or durability in a tire tread is measured in comparison to a comparably cured rubber composition that contains non-hydrogenated, non-functional styrene-butadiene polymer in place of the hydrogenated, functional conjugated diene polymer, and which styrene-butadiene polymer has a Tg that is similar to that of the hydrogenated, functional conjugated diene polymer. The improvement in wear or durability can be measured by calculating the wear index of the subject rubber composition. An improvement in wear or durability is considered to exist when the subject rubber composition has a wear index (measured under at least one slip percentage in the range of 5-75%) that is 110% or higher, based upon a comparably cured comparative rubber composition that contains no hydrogenated, functional conjugated diene polymer but contains a non-hydrogenated, non-functional styrene-butadiene polymer having a Tg that is similar to that of the hydrogenated, functional conjugated diene in a phr amount equal to the amount of the hydrogenated, functional conjugated diene polymer in the subject rubber composition. Correspondingly, such a rubber composition can also be said to exhibit reduced wear or have increased abrasion resistance. In certain embodiments, the improvement in wear or durability is exhibited by the subject rubber composition having a wear index (measured under at least one slip percentage in the range of 5-75% that is at least 115% or higher, and alternatively at least 120% or higher, based upon a comparably cured comparative rubber composition that contains no hydrogenated, functional conjugated diene polymer but contains a non-hydrogenated, non-functional styrene-butadiene polymer having a Tg that is similar to that of the hydrogenated, functional conjugated diene in a phr amount equal to the amount of the hydrogenated, functional conjugated diene polymer in the subject rubber composition. In certain of the foregoing embodiments, the wear index is calculated using measurements taken at 10% slip.

The rubber composition may be shaped and vulcanized for use in tire applications such as a tread, an under tread, a carcass, a sidewall, a bead and the like as well as a rubber cushion, a belt, a hose and other industrial products, but it is particularly suitable for use in the tire tread

The embodiments of the present disclosure are further illustrated by reference to the following examples.

### EXAMPLES

### Synthesis of Example 1

[2-(3,4-epoxycyclohexyl)ethyltrimethoxysilane] functionalized polybutadiene (BR) was prepared according to the following process. To a five gallon (approximately 18.9 liter) N2 purged reactor equipped with a stirrer was added 3.098 kilograms of hexane and 8.283 kilograms of 20.7 weight % 1,3-butadiene in hexane. The reactor was charged with 0.893 milliliters of 2,2-bis(2′-tetrahydrofuryl)propane (1.60 Molar in hexane), followed by 5.72 milliliters of n-butyllithium (2.50 Molar in hexane), and the reactor jacket was heated to 50° C. 40 minutes after the peak reaction temperature, the anionic polymerization reaction was terminated by adding 3.31 milliliters of [2-(3,4-epoxycyclohexyl)ethyltrimethoxysilane]. After an additional 30 minutes, 1.3 milliliters of isopropyl alcohol was added. After an additional 10 minutes, a sample of polymer cement was collected for characterization and the remaining cement was transferred to a storage vessel in preparation for transfer to a hydrogenation reactor. Polymer characterization data of the non-hydrogenated functionalized BR intermediate is summarized in Table 1.

### Synthesis of Example 2

[2-(3,4-epoxycyclohexyl)ethyltrimethoxysilane] functionalized styrene-butadiene copolymer (SBR) was prepared according to the following process. To a five gallon (approximately 18.9 liter) N2 purged reactor equipped with a stirrer was added 3.258 kilograms of hexane, 0.254 kilograms of 33.7 weight % styrene in hexane, and 7.869 kilograms of 20.7 weight % 1,3-butadiene in hexane. The reactor was charged with 1.965 milliliters of 2,2-bis(2′-tetrahydrofuryl)propane (1.60 Molar in hexane), followed by 5.72 milliliters of n-butyllithium (2.50 Molar in hexane), and the reactor jacket was heated to 50° C. 40 minutes after the peak reaction temperature, the anionic polymerization reaction was terminated by adding 3.31 milliliters of [2-(3,4-epoxycyclohexyl)ethyltrimethoxysilane]. After an additional 30 minutes, 1.3 milliliters of isopropyl alcohol was added. After an additional 10 minutes, a sample of polymer cement was collected for characterization and the remaining cement was transferred to a storage vessel in preparation for transfer to a hydrogenation reactor. Polymer characterization data of the non-hydrogenated functionalized SBR intermediate is summarized in Table 1.

### Synthesis of Example 3

[2-(3,4-epoxycyclohexyl)ethyltrimethoxysilane] functionalized styrene-butadiene copolymer (SBR) was prepared according to the following process. To a five gallon (approximately 18.9 liter) N2 purged reactor equipped with a stirrer was added 3.758 kilograms of hexane, 0.544 kilograms of 31.5 weight % styrene in hexane, and 7.079 kilograms of 21.8 weight % 1,3-butadiene in hexane. The reactor was charged with 1.965 milliliters of 2,2-bis(2′-tetrahydrofuryl)propane (1.60 Molar in hexane), followed by 5.72 milliliters of n-butyllithium (2.50 Molar in hexane), and the reactor jacket was heated to 50° C. 40 minutes after the peak reaction temperature, the anionic polymerization reaction was terminated by adding 0.66 milliliters of [2-(3,4-epoxycyclohexyl)ethyltrimethoxysilane]. After an additional 30 minutes, 1.3 milliliters of isopropyl alcohol was added. After an additional 10 minutes, a sample of polymer cement was collected for characterization and the remaining cement was transferred to a storage vessel in preparation for transfer to a hydrogenation reactor. Polymer characterization data of the non-hydrogenated functionalized SBR intermediate is summarized in Table 1.

### Synthesis of Example 4

[2-(3,4-epoxycyclohexyl)ethyltrimethoxysilane] functionalized styrene-butadiene copolymer (SBR) was prepared according to the following process. To a five gallon (approximately 18.9 liter) N2 purged reactor equipped with a stirrer was added 3.758 kilograms of hexane, 0.544 kilograms of 31.5 weight % styrene in hexane, and 7.079 kilograms of 21.8 weight % 1,3-butadiene in hexane. The reactor was charged with 0.982 milliliters of 2,2-bis(2′-tetrahydrofuryl)propane (1.60 Molar in hexane), followed by 4.47 milliliters of n-butyllithium (1.60 Molar in hexane), and the reactor jacket was heated to 50° C. 40 minutes after the peak reaction temperature, the anionic polymerization reaction was terminated by adding 1.65 milliliters of [2-(3,4-epoxycyclohexyl)ethyltrimethoxysilane]. After an additional 30 minutes, 0.7 milliliters of isopropyl alcohol was added. After an additional 10 minutes, a sample of polymer cement was collected for characterization and the remaining cement was transferred to a storage vessel in preparation for transfer to a hydrogenation reactor. Polymer characterization data of the non-hydrogenated functionalized SBR intermediate is summarized in Table 1.

### Synthesis of Example 5

ECETMOS [2-(3,4-epoxycyclohexyl)ethyltrimethoxysilane] functionalized styrene-butadiene copolymer (SBR) was prepared according to the following process. To a five gallon (approximately 18.9 liter) N2 purged reactor equipped with a stirrer was added 3.940 kilograms of hexane, 0.952 kilograms of 31.5 weight % styrene in hexane, and 6.489 kilograms of 21.8 weight % 1,3-butadiene in hexane. The reactor was charged with 0.595 milliliters of 2,2-bis(2′-tetrahydrofuryl)propane (1.60 Molar in hexane), followed by 3.81 milliliters of n-butyllithium (2.50 Molar in hexane), and the reactor jacket was heated to 50° C. 40 minutes after the peak reaction temperature, the anionic polymerization reaction was terminated by adding 1.32 milliliters of [2-(3,4-epoxycyclohexyl)ethyltrimethoxysilane]. After an additional 30 minutes, 0.9 milliliters of isopropyl alcohol was added. After an additional 10 minutes, a sample of polymer cement was collected for characterization and the remaining cement was transferred to a storage vessel in preparation for transfer to a hydrogenation reactor. Polymer characterization data of the non-hydrogenated functionalized SBR intermediate is summarized in Table 1.

TABLE 1
Synthesis of Functionalized BR and SBR for Hydrogenation

| Description | Example 1 | Example 2 | Example 3 | Example 4 | Example 5 |
|---|---|---|---|---|---|
| mmol n-BuLi phgm | 0.833 | 0.833 | 0.833 | 0.417 | 0.556 |
| Modifier/Li | 0.10 | 0.22 | 0.22 | 0.22 | 0.10 |
| Reactor jacket temperature | 50° C. | 50° C. | 50° C. | 50° C. | 50° C. |
| % Styrene | 0 | 6.4% | 11.0% | 11.0% | 18.5% |
| % 1,2 Bd (Vinyl Content) | 23.6% | 37.7% | 39.5% | 31.4% | 25.1% |
| GPC Data | | | | | |
| Mₙ (Base) | 164891 | 166231 | 214578 | 253538 | 270826 |
| M_{w} (Base) | 173665 | 173542 | 224736 | 262309 | 292006 |
| M_{w}/Mₙ (Base) | 1.053 | 1.044 | 1.047 | 1.035 | 1.078 |
| Mₙ (Funct. Peak) | 371732 | 379616 | 589361 | 568671 | 698164 |
| M_{w} (Funct. Peak) | 412503 | 429099 | 651294 | 646315 | 781983 |
| M_{w}/Mₙ (Funct. | 1.110 | 1.130 | 1.105 | 1.136 | 1.120 |
| Peak) | | | | | |
| DSC Data | | | | | |
| Tg (° C.) | −82.2 | −68.3 | −59* | −65* | −61* |

*estimated based on microstructure

### Example 6. Hydrogenation of Example

To a 11.7 gallon (approximately 44.3 liter) stirred reactor under nitrogen atmosphere, 5,715 g of the Example 1 BR solution in hexane was introduced, followed by 11,030 g of hexane, which resulted in a 5.0 wt % BR solution. The reactor was purged 3 times with 20 psi hydrogen and the reactor jacket was heated to 50° C. To a nitrogen purged dry bottle, 400 mL of hexane and 21.97 mL of 1.0 M triethylaluminum was added, followed by 3.99 mL of nickel octoate (10.1 wt % Ni in hexane), resulting in a Ni/Al catalyst (Al/Ni=3.3/1.0). The catalyst solution was transferred into the reactor, and the reactor was immediately pressurized to 75 psi with hydrogen. After 8 minutes of hydrogenation reaction, hydrogen was released from the reactor and the polymer cement was transferred to a storage vessel. The polymer cement was then transferred into 4 buckets, each containing 6.3 L of isopropanol and 11.5 g of butylated hydroxytoluene (BHT). The coagulated polymer sample was dried by a drum-drier at 120° C. Hydrogenation data is provided in Table 2 below.

### Example 7. Hydrogenation of Example 2

To a 11.7 gallon (approximately 44.3 liter) stirred reactor under nitrogen atmosphere, 5,543 g of the Example 2 SBR solution in hexane was introduced, followed by 10,686 g of hexane, which resulted in a 5.0 wt % SBR solution. The reactor was purged 3 times with 20 psi hydrogen and the reactor jacket was heated to 50° C. To a nitrogen purged dry bottle, 250 mL of hexane and 13.32 mL of 1.0 M triethylaluminum was added, followed by 2.42 mL of nickel octoate (10.1 wt % Ni in hexane), resulting in a Ni/Al catalyst (Al/Ni=3.3/1.0). The catalyst solution was transferred into the reactor, and the reactor was immediately pressurized to 75 psi with hydrogen. After 10 minutes of hydrogenation reaction, hydrogen was released from the reactor and the polymer cement was transferred to a storage vessel. The polymer cement was then transferred into 4 buckets, each containing 6.3 L of isopropanol and 11.5 g of butylated hydroxytoluene (BHT). The coagulated polymer sample was dried by a drum-drier at 120° C. Hydrogenation data is provided in Table 2 below.

### Example 8. Hydrogenation of Example 3

To a 11.7 gallon (approximately 44.3 liter) stirred reactor under nitrogen atmosphere, 11,430 g of the Example 3 SBR solution in hexane was introduced, followed by 5,315 g of hexane, which resulted in a 10.0 wt % SBR solution. The reactor was purged 3 times with 20 psi hydrogen and the reactor jacket was heated to 50° C. To a nitrogen purged dry bottle, 400 mL of hexane and 21.97 mL of 1.0 M triethylaluminum was added, followed by 3.99 mL of nickel octoate (10.1 wt % Ni in hexane), resulting in a Ni/Al catalyst (Al/Ni=3.3/1.0). The catalyst solution was transferred into the reactor, and the reactor was immediately pressurized to 75 psi with hydrogen. After 40 minutes of hydrogenation reaction, hydrogen was released from the reactor and the polymer cement was transferred to a storage vessel. The polymer cement was then transferred into 4 buckets, each containing 6.3 L of isopropanol and 11.5 g of butylated hydroxytoluene (BHT). The coagulated polymer sample was dried by a drum-drier at 120° C. Hydrogenation data is provided in Table 2 below.

### Example 9. Hydrogenation of Example 4

To a 11.7 gallon (approximately 44.3 liter) stirred reactor under nitrogen atmosphere, 5,670 g of the Example 4 SBR solution in hexane was introduced, followed by 10,940 g of hexane, which resulted in a 5.0 wt % SBR solution. The reactor was purged 3 times with 20 psi hydrogen and the reactor jacket was heated to 50° C. To a nitrogen purged dry bottle, 200 mL of hexane and 10.90 mL of 1.0 M triethylaluminum was added, followed by 1.98 mL of nickel octoate (10.1 wt % Ni in hexane), resulting in a Ni/Al catalyst (Al/Ni=3.3/1.0). The catalyst solution was transferred into the reactor, and the reactor was immediately pressurized to 75 psi with hydrogen. After hydrogenation, hydrogen was released from the reactor and the polymer cement was transferred to a storage vessel. The polymer cement was then transferred into 4 buckets, each containing 6.3 L of isopropanol and 11.5 g of butylated hydroxytoluene (BHT). The coagulated polymer sample was dried by a drum-drier at 120° C. Hydrogenation data is provided in Table 2 below.

### Example 10. Hydrogenation of Example 5

To a 11.7 gallon (approximately 44.3 liter) stirred reactor under nitrogen atmosphere, 5,715 g of the Example 5 SBR solution in hexane was introduced, followed by 11,030 g of hexane, which resulted in a 5.0 wt % SBR solution. The reactor was purged 3 times with 20 psi hydrogen and the reactor jacket was heated to 50° C. To a nitrogen purged dry bottle, 220 mL of hexane and 12.08 mL of 1.0 M triethylaluminum was added, followed by 2.19 mL of nickel octoate (10.1 wt % Ni in hexane), resulting in a Ni/Al catalyst (Al/Ni=3.3/1.0). The catalyst solution was transferred into the reactor, and the reactor was immediately pressurized to 75 psi with hydrogen. After hydrogenation, hydrogen was released from the reactor and the polymer cement was transferred to a storage vessel. The polymer cement was then transferred into 4 buckets, each containing 6.3 L of isopropanol and 11.5 g of butylated hydroxytoluene (BHT). The coagulated polymer sample was dried by a drum-drier at 120° C. Hydrogenation data is provided in Table 2 below.

TABLE 2
Hydrogenation of Functionalized BR and SBR

| Description | Example 6 | | Example 7 | | Example 8 | | Example 9 | | Example 10 | |
|---|---|---|---|---|---|---|---|---|---|---|
| mmol Ni phgm | 0.80 | | 0.50 | | 0.40 | | 0.40 | | 0.44 | |
| Al:Ni | 3.3 | | 3.3 | | 3.3 | | 3.3 | | 3.3 | |
| Hydrogenation Temp | 50° | C. | 50° | C. | 50° | C. | 50° | C. | 50° | C. |
| Hydrogenation Pressure | 75 | psig | 75 | psig | 75 | psig | 75 | psig | 75 | psig |

| | | | | | |
|---|---|---|---|---|---|
| Hydrogenation Extent | 77.3% | 81.0% | 95.0% | 83.2% | 76.1% |
| Tg (° C.) | −63.6 | −61.4 | −52.4 | −58.1 | −55.7 |

### Comparative Examples 1-2 and Examples 11-12

Referring to Table 3 below, rubber composition samples were produced from the above polymer and evaluated using various metrics. While the specific amounts are listed below, the rubber compositions, which were produced from mixing in a Brabender mixer, include the following components: SiO₂, oil, stearic acid, wax, 1,3-dimethylbutyl-N′phenyl-p-phenylenediamine (6PPD), and silane, while the cure package includes ZnO, sulfur, n-tertiary butyl-2-benzothiazole sulfenamide (TBBS), diphenylguanidine (DPG), and mercaptobenzothiazole disulfide (MBTS).

TABLE 3
Rubber Compositions Samples and Properties

| | Comp. | Comp. | Example | Example |
|---|---|---|---|---|
| Description | Example 1 | Example 2 | 11 | 12 |
| Masterbatch Stage | | | | |
| Comparative SBR¹ | 50 | 70 | 0 | 0 |
| High-cis BR² | 50 | 30 | 50 | 50 |
| Example 6 type HBR | 0 | 0 | 50 | 0 |
| Example 7 type HSBR | 0 | 0 | 0 | 50 |
| Silica³ | 50 | 50 | 50 | 50 |
| Carbon Black | 7 | 7 | 7 | 7 |
| Silane | 5 | 5 | 5 | 5 |
| Wax | 2 | 2 | 2 | 2 |
| Oil | 18 | 18 | 18 | 18 |
| Resin | 8 | 8 | 8 | 8 |
| Remill Stage | | | | |
| Silica³ | 41 | 41 | 41 | 41 |
| Silane | 4.1 | 4.1 | 4.1 | 4.1 |
| Resin | 10 | 10 | 10 | 10 |
| Stearic Acid | 2 | 2 | 2 | 2 |
| Process Aid | 1 | 1 | 1 | 1 |
| Antioxidant | 1.3 | 1.3 | 1.3 | 1.3 |
| Final Stage | | | | |
| Sulfur | 1.5 | 1.5 | 1.2 | 1.5 |
| Diphenylguanidine | 2 | 2 | 1.6 | 2 |
| N-Tertiary Butyl-2- | 1.25 | 1.25 | 1 | 1.25 |
| Benzothiazole | | | | |
| Sulfenamide | | | | |
| Mercaptobenzothiazole | 0.75 | 0.75 | 0.6 | 0.75 |
| disulfide | | | | |
| Zinc Oxide | 2.5 | 2.5 | 2.5 | 2.5 |
| Antioxidant | 0.22 | 0.22 | 0.22 | 0.22 |
| Physical Properties | | | | |
| M300 (MPa) | 10.5 | 11.1 | 14.7 | 14.1 |
| Tb (MPa) | 13.9 | 13.5 | 16.4 | 14.3 |
| Eb (%) | 391 | 363 | 332 | 303 |
| Compound Mooney | 75 | 70 | 153 | 109 |
| ML4 130C | | | | |
| Wear Index | 100 | 92 | 127 | 140 |

¹The Comparative SBR is HX263 manufactured by Firestone Chemical Company.
²High-cis BR is nickel catalyzed, having a cis-content of 95%
³The Silica is a high surface area silica with 190 m²/g surface area N₂ absorption.

Testing Methods

Mooney Viscosity

The Mooney viscosities of the rubber compositions disclosed herein were determined at 130° C. using an Alpha Technologies Mooney viscometer with a large rotor, a one minute warm-up time, and a four minute running time. More specifically, the Mooney viscosity was measured by preheating each sample to 130° C. for one minute before the rotor starts. The Mooney viscosity was recorded for each sample as the torque at four minutes after the rotor started. Torque relaxation was recorded after completing the four minutes of measurement.

Gel Permeation Chromatography (GPC)

The molecular weight (Mₙ, M_{w} and Mₚ-peak Mₙ of GPC curve) and molecular weight distribution (M_{w}/Mₙ) of the polymers were determined by GPC. The GPC measurements disclosed herein are calibrated with polystyrene standards and Mark-Houwink constants for the polystyrenes produced.

Differential Scanning Calorimetry (DSC)

DSC measurements were made on a TA Instruments Q2000 with helium purge gas and a Liquid Nitrogen Cooling System (LNCS) accessory for cooling. The sample was prepared in a TZero aluminum pan and scanned at 10° C./min over the temperature range of interest.

Viscoelastic Properties

Viscoelastic properties of cured rubber compositions were measured by a temperature sweep test conducted with an Advanced Rheometric Expansion System (ARES) from TA Instruments. The test specimen had a rectangular geometry having a length of 47 mm, a thickness of 2 mm, and a width of 12.7 mm. The length of specimen between the grips on the test machine, i.e., the gap, is approximately 27 mm. The test was conducted using a frequency of 62.8 rad/sec. The temperature is started at −100° C. and increased to 100° C. The strain is 0.1% or 0.25% for the temperature range of −100° C. to −10° C., and 2% for the temperature range of −10° C. and above.

Wear

The wear resistance of the test samples was evaluated using a Lambourn Abrasion Tester wherein an abrasion amount was obtained at a slip rate of 10%. The value is shown by an index, wherein the value in Comparative Example 1 was set to 100. The larger the indexed value, the better the abrasion resistance is.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A polymer comprising:
a functional polymer produced by polymerization of at least one conjugated diolefin monomer and optionally one or more aromatic vinyl monomers, the functional polymer comprising at least one functional group having silica reactive moieties,
wherein the functional polymer has a degree of hydrogenation of 40% to 98 mol % as measured using proton nuclear magnetic resonance spectroscopy (¹H NMR); and
wherein the functional polymer has a vinyl content of from about 15% to about 50%; and
wherein an Mn of the functional polymer is from about 100,000 to about 700,000 grams/mole; and
wherein a Tg of the functional polymer is from about −100° C. to −40° C.

2. The polymer of claim 1, wherein the silica reactive moieties comprise one or more groups selected from alkoxysilyl, hydroxyl, polyalkylene glycol, silanol, silyl halide, anhydride, organic acid, epoxy groups and combinations thereof.

3. The polymer of claim 1, wherein:
the functional polymer is produced by polymerization of 1,3-butadiene monomer and from 0 to about 20% by weight styrene monomer; and
wherein the at least one functional group is added by reaction of an active terminal of a polymer chain with a compound having the following Formula (II): 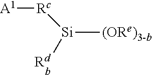
wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having 1 to 20 carbon atoms, a monovalent aromatic hydrocarbon group having 6 to 18 carbon atoms or a reactive group; R^{e} represents a monovalent aliphatic hydrocarbon group having 1 to 20 carbon atoms or a monovalent aromatic hydrocarbon group having 6 to 18 carbon atoms; b is an integer of 0 to 2; when more than one R^{d} or OR^{e} are present, each R^{d} and/or OR^{e} may be the same as or different from each other; and an active proton is not contained in a molecule) and/or a partial condensation product thereof.

4. The polymer of claim 1, wherein: the functional polymer has a degree of hydrogenation of from about 65% to about 85 mol % as measured using proton nuclear magnetic resonance spectroscopy (¹H NMR); the functional polymer has an Mn from about 200,000 to about 500,000 grams/mole.

5. The polymer of claim 1, wherein the at least one functional group is added by reaction of an active terminal of a polymer chain with 2-(3,4-epoxycyclohexyl) ethyltrimethoxysilane.

6. The polymer of claim 1, wherein:
the functional polymer is produced by polymerization of 1,3-butadiene monomer and from 0 to about 10% by weight styrene monomer.

7. A rubber composition comprising:
(a) 100 phr of an elastomer component comprising a hydrogenated functional polymer produced by polymerization of at least one conjugated diolefin monomer and optionally one or more aromatic vinyl monomers, the functional polymer comprising at least one functional group having silica reactive moieties, and wherein the functional polymer has a degree of hydrogenation of 40% to 98 mol % as measured using proton nuclear magnetic resonance spectroscopy (¹H NMR); a vinyl content of from about 15% to about 50%; an Mn of from about 100,000 to about 700,000 grams/mole; and a Tg of from about −100° C. to −40° C.;
(b) silica reinforcing filler; and
(c) a cure package.

8. The rubber composition of claim 7, wherein:
the functional polymer is produced by polymerization of 1,3-butadiene monomer and from 0 to about 20% by weight styrene monomer; and
wherein the at least one functional group is added by reaction of the active terminal of a polymer chain with a compound having the following Formula (II): 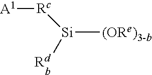
wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having 1 to 20 carbon atoms, a monovalent aromatic hydrocarbon group having 6 to 18 carbon atoms or a reactive group; R^{e} represents a monovalent aliphatic hydrocarbon group having 1 to 20 carbon atoms or a monovalent aromatic hydrocarbon group having 6 to 18 carbon atoms; b is an integer of 0 to 2; when more than one R^{d} or OR^{e} are present, each R^{d} and/or OR^{e} may be the same as or different from each other; and an active proton is not contained in a molecule and/or a partial condensation product thereof.

9. The rubber composition of claim 7, wherein the functional polymer has a degree of hydrogenation of from about 65% to about 85 mol % as measured using proton nuclear magnetic resonance spectroscopy (¹H NMR) and an Mn from about 200,000 to about 500,000 grams/mole.10.

10. The rubber composition of claim 7, wherein the elastomer component comprises about 30 to about 70 phr of the hydrogenated functional polymer, wherein a remainder of the elastomer is selected from the group consisting of: styrene-butadiene rubbers having a Tg of between about −80° C. and about −30° C.; polybutadiene rubbers having a cis bond content of less than 95% and a Tg of less than −101° C.; polybutadiene rubbers having a cis bond content of greater than 85% and a Tg of less than −101° C.; and natural rubber, synthetic polyisoprene rubber, or combinations thereof.

11. The rubber composition of claim 7, wherein the silica reinforcing filler is present in an amount of from about 30 phr to about 150 phr; and wherein the cure package comprises sulfur.

12. The rubber composition of claim 7, wherein the at least on functional group is added by reaction of an active terminal of a polymer chain with 2-(3,4-epoxycyclohexyl)ethyltrimethoxysilane.

13. The rubber composition of claim 7, wherein:
the functional polymer is produced by polymerization of 1,3-butadiene monomer and from 0 to about 10% by weight styrene monomer.

14. The rubber composition of claim 7, wherein upon curing, the rubber composition exhibits reduced wear as exhibited by having a wear index measured under at least one slip percentage in a range of 10-75% that is 110% or higher, based upon a comparably cured comparative rubber composition that contains no hydrogenated, functional conjugated diene polymer but contains a non-hydrogenated, non-functional styrene-butadiene polymer having a Tg that is similar to that of the hydrogenated, functional conjugated diene in a phr amount equal to the amount of the hydrogenated, functional conjugated diene polymer in the rubber composition.

15. The rubber composition of claim 7, wherein the rubber composition is incorporated in a tire tread.

16. A method of making a hydrogenated functional polymer comprising:
introducing an anionic polymerization initiator, at least one conjugated diolefin monomer, and optionally one or more vinyl monomer, and solvent to a reactor to produce a living polymer via anionic polymerization;
reacting at least one functional group comprising silica reactive moieties with the living polymer to produce a functional polymer; and
hydrogenating the functional polymer by mixing the functional polymer with solvent and a hydrogenation catalyst in a hydrogen stream, wherein the hydrogenated functional polymer has a degree of hydrogenation of 40% to 98 mol % as measured using ¹H NMR; a vinyl content of from about 15% to about 50%; an Mn of from about 100,000 to about 700,000 grams/mole; and a Tg of from about −100° C. to −40° C.

17. The method of claim 16, wherein the hydrogenation catalyst comprises nickel and aluminum, and the anionic polymerization initiator is a lithium catalyst.

18. The method of claim 16, wherein the hydrogenation catalyst comprises nickel octoate.

19. The method of claim 16, wherein the functional group is added by reaction of an active terminal of a polymer chain with a 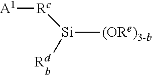
compound having the following Formula (II):
wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having 1 to 20 carbon atoms, a monovalent aromatic hydrocarbon group having 6 to 18 carbon atoms or a reactive group; R^{e} represents a monovalent aliphatic hydrocarbon group having 1 to 20 carbon atoms or a monovalent aromatic hydrocarbon group having 6 to 18 carbon atoms; b is an integer of 0 to 2; when more than one R^{d} or OR^{e} are present, each R^{d} and/or OR^{e} may be the same as or different from each other; and an active proton is not contained in a molecule) and/or a partial condensation product thereof.

20. The method of claim 16, wherein the hydrogenated functional polymer has a vinyl content of from about 15 to about 40% and the degree of hydrogenation of the functional copolymer is at least 65 mol %.

21. (canceled)

22. (canceled)
